(19) United States
(12) Patent Application Publication
(10) Pub. No.: US 2008/0170672 A1
(43) Pub. Date: Jul. 17, 2008

(54) Enhanced telecommunications greeting system

(75) Inventor: Yigang Cai, Naperville, IL (US)

Correspondence Address: Werner Ulrich, 434 Maple Street, Glen Ellyn, IL, 60137, US

(73) Assignee: Lucent Technologies, Inc.

(21) Appl. No.: 11/653,736

(22) Filed: Jan. 16, 2007

(51) Int. Cl. H04M 3/533; H04M 3/42

(52) U.S. Cl. 379/88.13; 379/88.19

(57) ABSTRACT

This invention relates to a method and apparatus for returning custom greetings to callers of a station that is not answering a telecommunications call. The greeting can be a specific message for one caller, while other callers receive a standard greeting. Callers are identified by incoming calling line identification or by a uniform resource identifier. The message can be time sensitive so that it is activated only at specified times. The message can also be used to elicit a request from the caller to access data in the called party's database. Advantageously, special messages can be left for individual callers without disturbing the normal answering process.

### TECHNICAL FIELD

This invention relates to a method and apparatus for providing greeting messages to a caller on a telecommunications call.

### BACKGROUND OF THE INVENTION

Telecommunications answering systems are widely used. Some of these systems, such as voice mail, are provided from a common carrier network. Others, such as customer premises equipment answering machines, also provide arrangements for recording caller messages. All of these systems have the feature of a greeting message which is initially played to the caller to indicate that the called party is not answering the call and inviting the caller to leave a message. Applicant's invention is aimed at enhancing the usefulness of the greeting function.

### SUMMARY OF THE INVENTION

The greeting function is substantially enhanced in usefulness in accordance with Applicant's invention wherein the greeting can be customized for responding to calls from particular callers; the greeting message is controlled by the called party for both customer premises equipment answering systems and network based answering systems; incoming caller identification is used to identify the calling party in order to select an appropriate customized message for that calling party.

The arrangements for incoming caller identification include incoming calling line identification (ICLID), calling internet protocol (IP) caller identification such as the Uniform Resource Identifier (URI) or caller domain identification. Advantageously, the greeting is used not only to inform the caller that the called party is not answering the call and to invite the caller to leave a message, but can also be used to provide special information of use to particular calling parties.

In accordance with one feature of Applicant's invention, the customized message can be time sensitive so that a particular message is activated only for a specified time interval and a more standard message is used at other times; this feature can be invoked for all callers (“I will be on vacation”) or for a special message to a specific caller (“Harry, please call me at 555-1234”). Advantageously, this arrangement can be used to provide information, such as the period of absence of the called party, that is of use to the caller or callers only at one or more specific time periods.

In accordance with another feature of Applicant's invention, the greeting message can include a data message or a voice message to specific callers. Either type of message can be used to elicit a specific voice or data message (“Please leave me Harry Jones's telephone number”). Advantageously, the caller can receive a data message believed to be of importance by the called party even if the called party is unavailable to answer the call.

In accordance with another feature of Applicant's invention, the greeting can be used to elicit a request from the caller to access selected data in the called party's database. Advantageously, this permits the caller to perform such accesses even if the called party is not available and to provide such access only to selected callers.

In accordance with another feature of Applicant's invention, the answering system can send a message to the caller's station equipment requesting information about the types of data formats supported and preferred by the caller in order to allow the answering system to send a message to the caller in a format acceptable to that caller.

In accordance with another feature of Applicant's invention, the greeting system can provide the caller with a link to a document source that the called party believes to be of interest to the caller or can provide a list of such links for the caller to select. Advantageously, the caller can get controlled access to a large body of data sources even if the called party is unavailable.

In accordance with another feature of Applicant's invention, the called party can send a message other than a voice or data message if the caller is equipped with a multimedia device. When necessary, the called party station equipment sends a message to the calling party station equipment to elicit a return message identifying the caller's type of device and the type of format that this device will accept.

In accordance with another feature of Applicant's invention, the caller identification can be a telephone number, an internet protocol (IP) address, a domain identification, or, more generally, any Uniform Resource Identifier (URI). Advantageously, this permits the called party greeting system to communicate with many different types of callers.

### BRIEF DESCRIPTION OF THE DRAWINGS

FIG. 1 is a block diagram illustrating the operation of Applicant's invention;

FIG. 2 is a flow diagram illustrating the operation of Applicant's invention; and

FIG. 3 is a flow diagram illustrating a called party's control of greeting messages.

### DETAILED DESCRIPTION

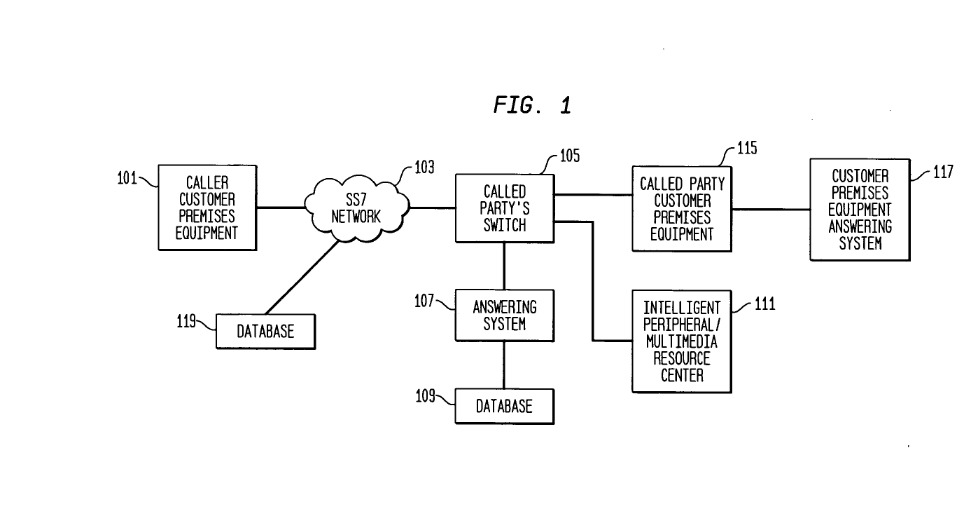

FIG. 1 is a block diagram illustrating the operation of Applicant's invention. A caller customer premises equipment system 101 is connected via a signaling system 7 (SS7) network 103 to a called party's switch 105. The caller's equipment 101 can include a computer and a multimedia display (not shown). The switch may be a call control function, such as a Call Session Control Function in the IMS network, or a data router in a data network. The switch is connected to a network based answering system 107 which controls the functions of the greeting arrangement of Applicant's invention. The answering system 107 has access to a database 109 which contains the data for determining what greeting arrangement is to be provided in a call from a caller identified by caller identification (ICLID) or such other caller identifications as an Internet Protocol (IP) caller identification, and also contains the data of greeting messages. As explained below, the greeting message can be a function of the identity of the caller, received via incoming calling line identification (ICLID). The answering system first screens the incoming caller ID to determine the retrieval of the greeting message from the database using the message ID (or label) The answering system delivers outputs based on the information obtained from database 109 to an intelligent-peripheral/multimedia resource center (MRC) (sometimes called a multimedia resource function (MRF)) 111. In a legacy network, an intelligent peripheral is used, but in 3G networks, a multimedia resource center is provided. The intelligent peripheral is connected via the called party's switch 105 and the SS7 network 103 to the caller system 101.

For customer premises based equipment, the called party equipment 115 includes or is connected to an answering system 117 which contains the facilities for carrying out the functions of answering system 107 and also contains an intelligent peripheral and a database. Called party equipment 115 can call on the resources of answering system 117 to perform the functions carried out by answering system 107, database 109, and intelligent peripheral/multimedia resource function 111.

The called party can provide a link or a list of links to the caller. The caller can then access a database 119 using one or more of these links.

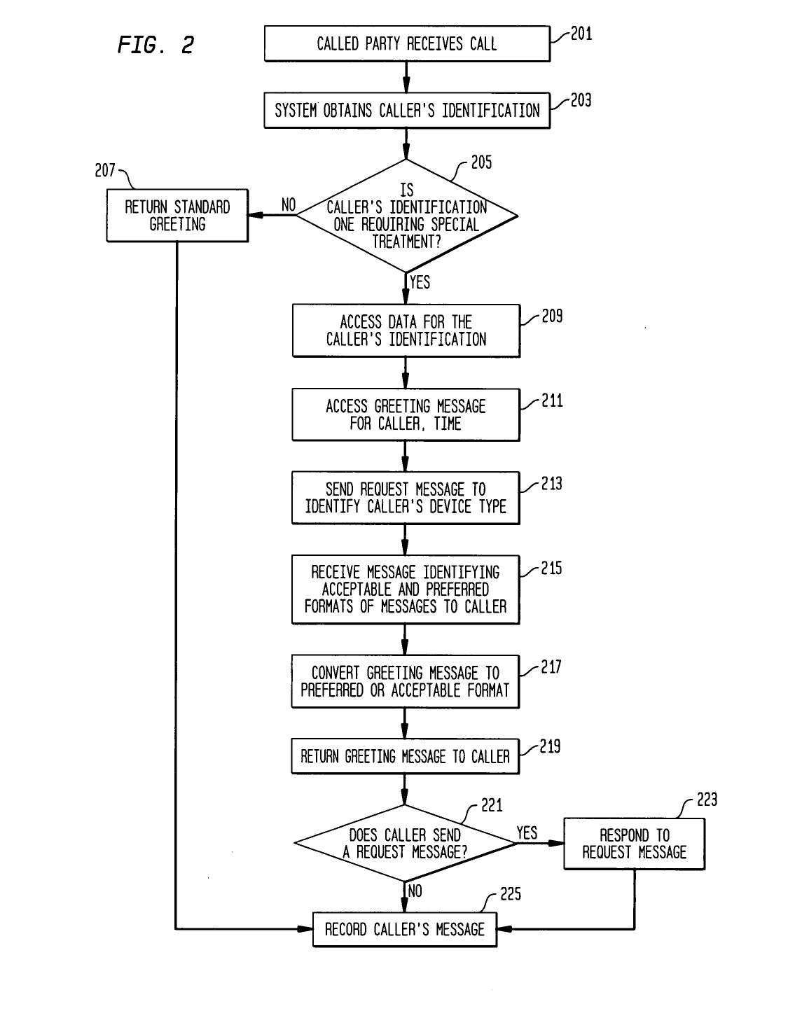

FIG. 2 is a flow diagram illustrating the operation of Applicant's invention. The actions discussed below can be controlled from answering system 107 or answering system 117. A called party receives a call (action block 201). The telecommunications network obtains the caller's identification (action block 203). Test 205 determines whether the caller's identification is one requiring special treatment, i.e., a customized greeting. If not, then return the standard greeting to the caller (action block 207).

If customized greeting treatment is required for this caller's identification, access data using the caller's identification and the called party's identification (action block 211). The data would consist of tables of labels for this caller and for different times if different messages are to be sent at different times. If the data for the caller's identification indicates the need for sending a request message to the caller to identify the caller's device type, then this message is sent (action block 213). The caller's equipment sends back a message identifying acceptable and preferred formats of messages to the caller and the message from the caller is received by the system (action block 215). Based on the acceptable and preferred formats, the greeting message obtained in action block 211 is converted to a preferred or acceptable format (action block 217). The greeting message in the appropriate format is then returned to the caller (action block 219). Test 221 determines whether the caller has sent a request message. An attached data file if specified by the called party is returned within the greeting message.

If a link to data is included in the greeting message, the caller will have the option to access the link, which is outside control of the called party's answering system. For instance, the called party includes a CNN news link in the greeting message. The caller will click the link and access the CNN web site directly. If the called party attaches a document (word file) in the greeting message, the caller will click and access the identified database to obtain the file. The database can be in the network, or the called party local computer, or the answering system database. The caller may need a password to access the document. If so, the greeting system takes steps necessary to respond to the request message (action block 223). This response may be a data file accessible by the caller party's equipment or it may be a link to such data. Under the control of the caller, the appropriate data file(s) are accessed and transmitted to the caller.

Subsequent to all of these actions, the answering system records the caller's message (action block 225).

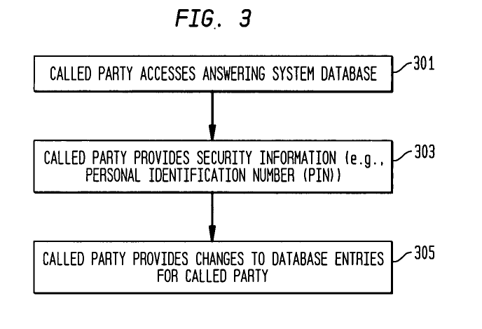

FIG. 3 is a flow diagram illustrating the operation of the process of changing data in the answering system database, thus illustrating a called party's control of greeting messages. A terminal of the called party, or acting for the called party (terminal not shown) accesses the answering system database (action block 301). The terminal provides security information, such as a personal identification number, and an identity of the called party (action block 303). The called party, after having passed a security dialog, then provides changes to the database entries for the called party.

The above description is of one preferred embodiment of Applicant's invention.

I claim:

1. A method of responding to an incoming telecommunications call when a called party of said call does not answer the call, comprising the steps of:
receiving said telecommunications call;
obtaining an identification of a caller of said call;
determining whether the identified caller is to be given special greeting treatment on calls to the called party;
if it is determined that said caller is to be given special greeting treatment, obtaining data for providing said special greeting treatment to said caller; and
returning a greeting message to said caller based on said data for the identified caller.

2. The method of claim 1 wherein said greeting message is used to request that said caller access data identified in said greeting message.

3. The method of claim 1 wherein said greeting message provides an identification of a data file for said caller to access.

4. The method of claim 1 wherein the step of returning a greeting message comprises the steps of:
sending a message to said caller to identify equipment and formats for receiving a greeting message;
receiving a response identifying equipment and formats usable by equipment of said caller; and
sending said greeting message in a format acceptable to said equipment of said caller.

5. The method of claim 1 wherein said greeting message is a multimedia message acceptable by equipment of said caller.

6. The method of claim 1 wherein said step of obtaining an identification comprises the step of:
obtaining said identification by one of incoming calling line identification, internet protocol caller identification, or domain identification.

7. The method of claim 1 wherein different greetings are provided to said caller at different times.

8. The method of claim 1, further comprising the step of:
changing said data under the control of said called party.

9. Apparatus for responding to an incoming telecommunications call when a called party of said call does not answer the call, comprising the steps of:
means for receiving said telecommunications call;
means for obtaining an identification of a caller of said call;
means for determining whether the identified caller is to be given special greeting treatment on calls to the called party;
responsive to a determination, means for that said caller is to be given special greeting treatment, obtaining data for providing said special greeting treatment to said caller; and
means for returning a greeting message to said caller based on said data for the identified caller.

10. The apparatus of claim 9 wherein said greeting message comprises data to request that said caller access data identified in said greeting message.

11. The apparatus of claim 9 wherein said greeting message comprises data for identifying a data file for said caller to access.

12. The apparatus of claim 9 wherein means for returning a greeting message comprises:
means for sending a message to said caller to identify equipment and formats for receiving a greeting message;
means for receiving a response identifying equipment and formats usable by equipment of said caller; and
means for sending said greeting message in a format acceptable to said equipment of said caller.

13. The apparatus of claim 9 wherein said greeting message comprises a multimedia message acceptable by equipment of said caller.

14. The apparatus of claim 9 wherein said means for obtaining an identification comprises the step of:
means for obtaining said identification by one of incoming calling line identification, internet protocol caller identification, or domain identification.

15. The apparatus of claim 9 wherein said means for returning a greeting message comprises means for returning different greeting messages to said caller at different times.

16. The apparatus of claim 9 further comprising means for changing said data under the control of said called party.

17. The method of claim 1 wherein said greeting message comprises a file of data.

18. The apparatus of claim 9 wherein said means for returning a greeting message comprises means for returning a file of data.
